(19) United States
(12) Patent Application Publication
(10) Pub. No.: US 2024/0342529 A1
(43) Pub. Date: Oct. 17, 2024

(54) SYSTEMS AND METHODS FOR COOLING HEATED AREAS AND FOR AIDING IN EXTINGUISHING FIRES

(71) Applicant: Turtle Fire Systems, LLC, Jersey City, NJ (US)

(72) Inventor: Howard Hayes, Kearny, NJ (US)

(21) Appl. No.: 18/679,167

(22) Filed: May 30, 2024

Related U.S. Application Data
(63) Continuation of application No. PCT/US2023/070291, filed on Jul. 14, 2023.
(63) Continuation-in-part of application No. 29/866,115, filed on Aug. 29, 2022.
(63) Continuation-in-part of application No. 29/868,454, filed on Dec. 2, 2022.
(63) Continuation-in-part of application No. 29/869,752, filed on Jan. 9, 2023.
(63) Continuation-in-part of application No. 29/912,602, filed on Sep. 20, 2023.
(60) Provisional application No. 63/389,083, filed on Jul. 14, 2022.
(60) Provisional application No. 63/386,236, filed on Dec. 6, 2022.

(51) Int. Cl. A62C 99/00; A62C 31/05; A62C 35/68

(52) U.S. Cl. CPC A62C 99/0072; A62C 31/05; A62C 35/68

(57) ABSTRACT

In accordance with some aspects, the disclosure provides implementations of device for aiding in extinguishing fires. The device includes a body surrounding a volume defining a fluid plenum. The body defining a plurality of exit ports therethrough to direct pressurized fluid at a target, and at least one fluid input port to couple to a pressurized fluid source.

### CROSS-REFERENCE TO RELATED APPLICATIONS

The present patent application is a continuation of and claims the benefit of priority to International Patent Application No. PCT/US2023/070291, filed Jul. 14, 2023, which in turn claims the benefit of priority to U.S. Provisional Application No. 63/389,083, filed Jul. 14, 2022 and U.S. Provisional Application No. 63/386,236, filed Dec. 6, 2022. The present patent application is a continuation-in-part of and claims the benefit of priority to each of U.S. Design application Ser. No. 29/866,115, filed Aug. 29, 2022, U.S. Design application Ser. No. 29/868,454, filed Dec. 2, 2022, U.S. Design application Ser. No. 29/869,752, filed Jan. 9, 2023, and U.S. Design application Ser. No. 29/912,602, filed Sep. 20, 2023. Each of the foregoing patent applications is incorporated by reference herein in its entirety for all purposes.

### FIELD

The present disclosure relates generally to fire extinguishing devices.

### BACKGROUND

Various fire extinguishing devices are known in the art. However, the existing approaches for extinguishing fires have proved ineffective for certain types of fires. The present disclosure addresses these and other needs in the art.

### SUMMARY OF THE DISCLOSURE

The disclosure provides implementations of a distributor to deliver water or other cooling fluid to a burning object, such as a burning vehicle, building, or structure. More specifically, implementations of the present disclosure can include a device that can connect to a standard firehose, for example, to efficiently aid in extinguishing a fire, such as a fire in a battery pack of an electric vehicle. Alternatively, devices made in accordance with the present disclosure can be attached for use in stationary applications, such as in rigid plumbing installations.

Devices made in accordance with the present disclosure can, under typical operating conditions, deliver water to a target location in amounts upwards of 400 gallons of water per minute, for example, for extinguishment and can easily be deployed underneath a vehicle from a relatively safe distance. However, devices made in accordance with the present disclosure can be designed in a manner to provide effective cooling where large fluid flow rates are not available or not permitted due to environmental and other considerations.

Society over recent years has turned its energy focus towards renewable energy, creating a demand for electric vehicles. The demand for electric vehicles has naturally created a demand in the improvement of battery technology. Unfortunately, in many electric vehicle battery configurations, due to manufacturing defects, faulty components, and/or poor designs, the battery pack can reach a point where it overheats and begins burning, resulting in electric vehicle fires. As a result, electric vehicle fires, originating in the battery packs, have become frequent. But, many if not most fire departments are not properly equipped to deal with electric vehicle fires. This is due to the amount of time and effort needed to extinguish electrical vehicle fires. Charged vehicle battery packs contain an enormous amount of chemical potential energy that is transformed into heat energy during a fire, so a great deal of water must be delivered to the battery pack to get the fire under control. This is exacerbated by the fact that battery packs in EVs are typically positioned near the underside of the vehicle in an area that is not easily accessible.

An objective of the present disclosure is to provide users with devices, such as a solid, fire-resistant firehose extension and water distributor, to help aid in extinguishing electric vehicle fires as well as other types of fires. The present disclosure intends to provide users with a device that can be easily deployed and operated from a relatively safe distance from the fire. In order to accomplish this, a preferred embodiment of the present disclosure can include a base and a hose connection. Further, the hose connection helps ensure the user can operate implementations of the present disclosure at a safe distance from the electrical vehicle fire while targeting areas that are not easily accessible. The firehose extension can be a solid, fire-resistant conduit, such as steel pipe, that resists compressive loads, such as the weight of a car falling on top of the pipe that would otherwise cut off flow of a fire hose. Thus, some implementations in accordance with the present disclosure can include a firehose attachment that can easily be deployed underneath an electric vehicle to efficiently aid in extinguishing an electric vehicle fire quickly and from a relatively safe distance.

In accordance with some aspects, the disclosure provides implementations of device for aiding in extinguishing fires. The device includes a body surrounding a volume defining a fluid plenum. The body defining a plurality of exit ports therethrough to direct pressurized fluid at a target, and at least one fluid input port to couple to a pressurized fluid source.

In accordance with further aspects of the disclosure, the body can be defined by a base plate configured to be slid along the ground and an upper surface above the base plate, wherein the base plate and the upper surface cooperate to define the fluid plenum, and the wherein the plurality of exit ports are formed through the upper surface. The device can further include a conduit fluidly coupled to one or more of the base plate and upper surface, wherein the conduit terminates in the fluid input port, the fluid input port being configured to be coupled to a fire hose. The device can be between about twelve and about thirty inches in lateral dimension, and between about two and about eight inches in height, in some implementations. The base plate and the upper surface can be fused along their periphery to form the fluid plenum.

In accordance with further aspects of the disclosure, the device can be configured to direct between about 300 gallons per minute and about 500 gallons per minute through the plurality of exit ports. If desired, the base plate can define a ramped portion to facilitate sliding the device along the ground, wherein the ramped portion is located on the body in a location that is across from the fluid input port. If desired, the conduit can extend along a direction parallel to the base plate.

In accordance with further aspects of the disclosure, the device can further include an extension conduit removably coupled to the conduit. In some aspects, the body can have a circular, triangular, rectangular, pentagonal, hexagonal, or octagonal shape when viewed in a top view, among others. If desired, the body and conduit can be formed from steel.

In accordance with further aspects, methods of extinguishing a fire are provided that include providing a device as set forth herein, coupling the device to a fluid source, placing the device proximate a fire, and extinguishing the fire.

In accordance with further aspects of the disclosure, the fire can be an electric vehicle (“EV”) fire, among others. In the case of an EV fire, the device can be deployed by sliding the device underneath the battery pack of the EV, and the extinguishing step can include directing water through the device to cool the battery pack of the EV. The device can be slid under a first side of the electric vehicle by pulling it under the vehicle from a second side of the electric vehicle. Water can be directed through the device and into contact with the EV at a volume flow rate between about 80 GPM and about 500 GPM, between about 350 GPM and about 500 GPM, or between about 450 GPM and about 500 GPM, for example. In further accordance with the disclosure, the device can include between one and 100 exit ports, or any increment therebetween of one exit port.

In further accordance with the disclosure, a stationary fire suppression system and related method are provided comprising a high-pressure standpipe coupled to a device as set forth herein. Such a stationary system can be used in any setting where high fluid volume flowrates are desired.

Additional objects, features, and/or advantages will be set forth in part in the description which follows, and in part will be obvious from the description, or may be learned by practice of the present disclosure and/or claims. At least some of these objects and advantages may be realized and attained by the elements and combinations particularly pointed out in the appended claims.

It is to be understood that both the foregoing general description and the following detailed description are illustrative and explanatory only and are not restrictive of the claims; rather the claims should be entitled to their full breadth of scope, including equivalents.

### BRIEF DESCRIPTION OF THE DRAWINGS

The present disclosure can be understood from the following detailed description, either alone or together with the accompanying drawings. The drawings are included to provide a further understanding of the present disclosure and are incorporated in and constitute a part of this specification. The drawings illustrate one or more embodiments of the present teachings and together with the description explain certain principles and operation. In the drawings, wherein:

FIG. 1 is a back side plan view of an implementation in accordance with the present disclosure.

FIG. 2 is a right-side plan view of the implementation of FIG. 1.

FIG. 3 is a left side plan view of the implementation of FIG. 1.

FIG. 4 is a front side plan view of the implementation of FIG. 1.

FIG. 5 is a top plan view of the implementation of FIG. 1.

FIG. 6 is a bottom plan view of the implementation of FIG. 1.

FIG. 7 is an upper right rear isometric view of the implementation of FIG. 1.

FIG. 8 is an upper right front isometric view of the implementation of FIG. 1.

FIG. 9 is a lower right rear isometric view of the implementation of FIG. 1.

FIG. 10 is an upper right rear isometric view of the implementation of FIG. 1 with an extension pipe attached, and with the main body portion broken up to illustrate an internal cavity of the device.

FIG. 11 is a top plan view of an alternative implementation in accordance with the present disclosure.

FIGS. 12-16 are top plan schematic views of further implementations in accordance with the present disclosure.

FIG. 17 is a schematic view of a further implementation in accordance with the present disclosure.

### DETAILED DESCRIPTION

All illustrations herein are for the purpose of describing selected implementations in accordance with the present disclosure and are not intended to limit the scope of the present disclosure.

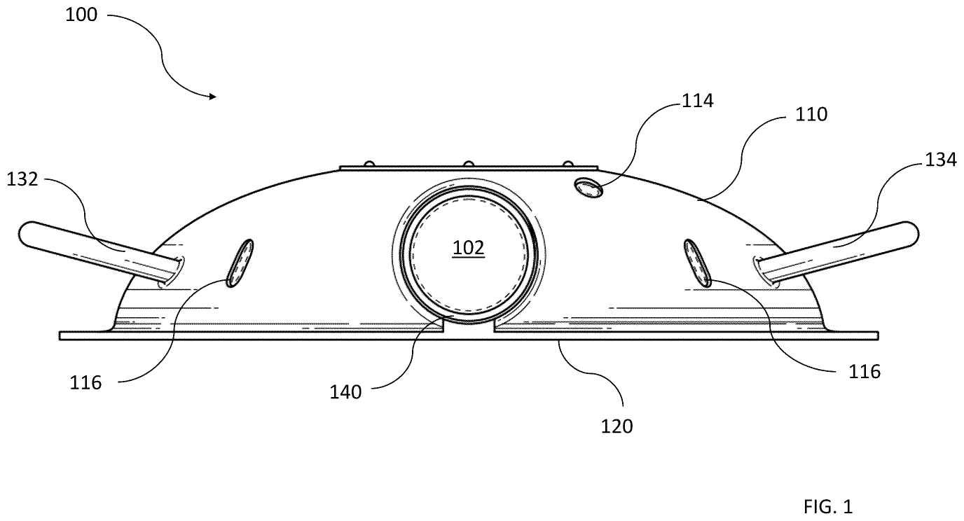

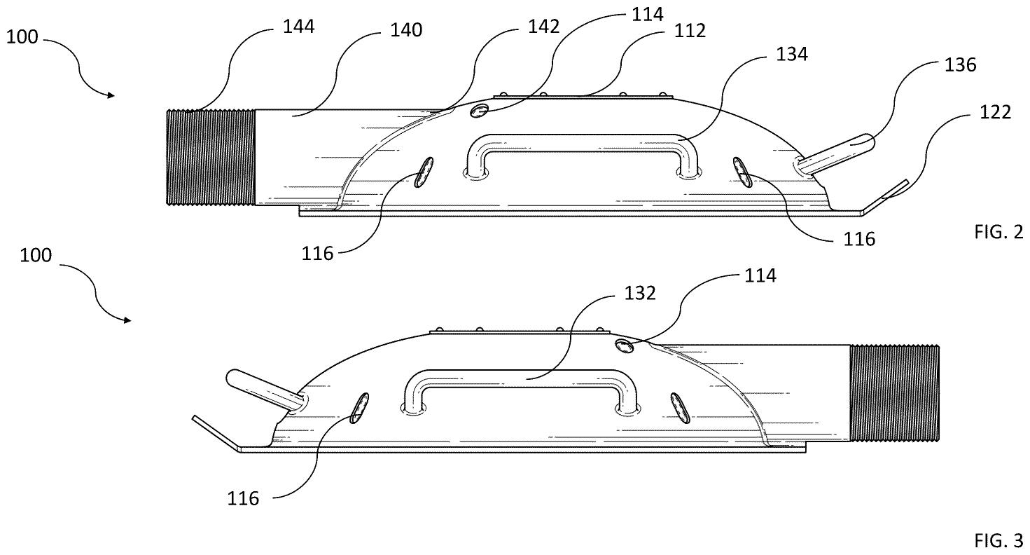

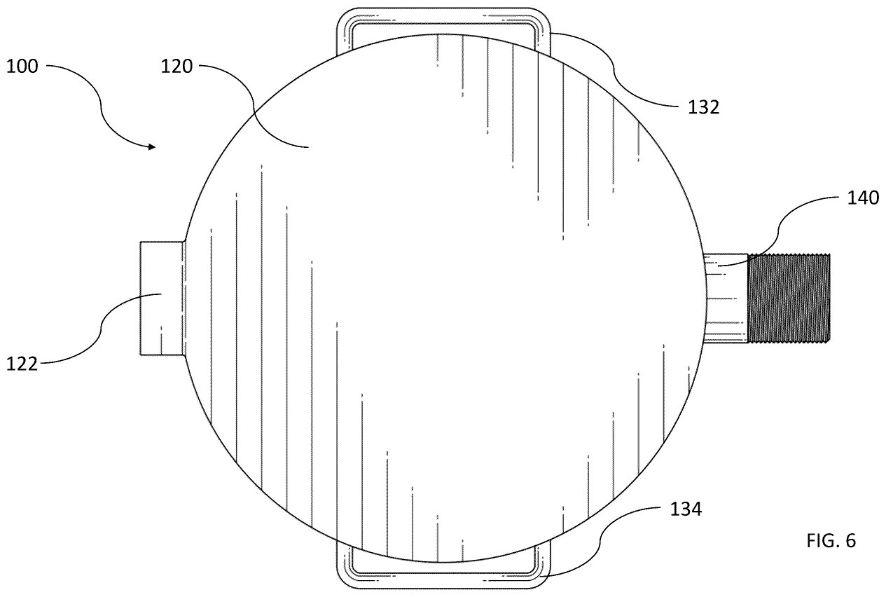

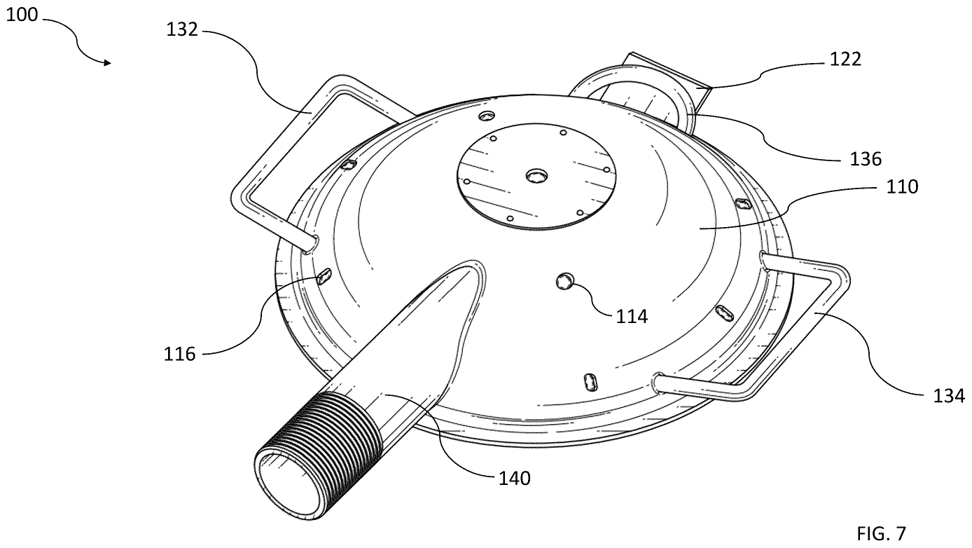

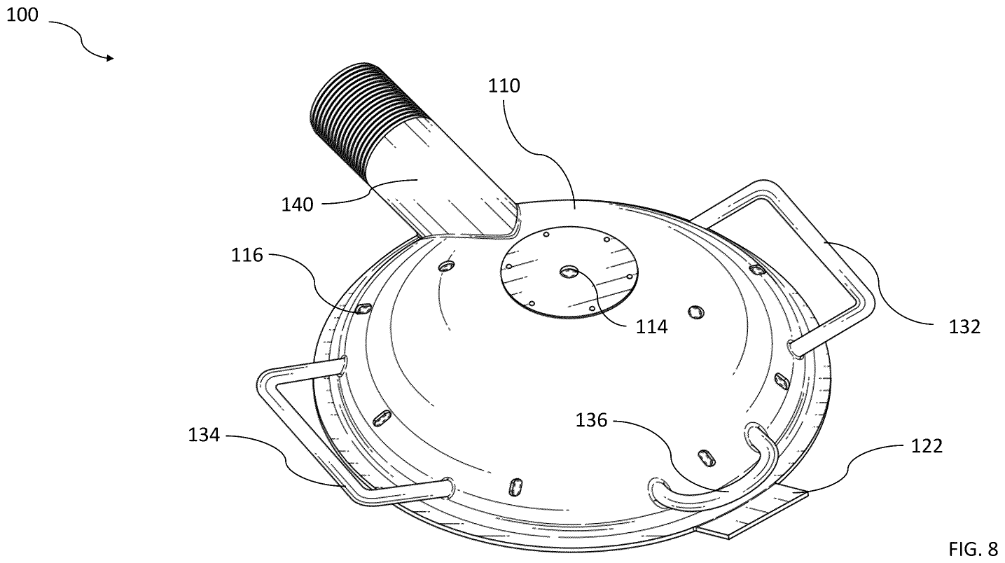

For purposes of illustration, and not limitation, as embodied herein, FIGS. 1-9 present an illustrative implementation of a fire extinguishing apparatus 100 in accordance with the present disclosure. An objective of the present disclosure is to provide users with a device that can efficiently aid in extinguishing electric vehicle fires, among other fires. The present disclosure provides users with a device that reaches areas under an electric vehicle, for example, or other hard to reach areas, that are not easily accessible while discharging high volumes of water per minute with a large coverage area.

To accomplish this, device 100 includes a body that surrounds a partially or fully hollow volume that forms a plenum for receiving a liquid such as water under high pressure. The illustrated body of device 100 is formed from a base plate 120 that is connected about its periphery to an upper shell portion 110, wherein shell portion and base plate cooperate to form an interior volume or plenum 102 to receive pressurized fluid. The shell 110 can define a plurality of openings 114, 116 therethrough to permit a cooling, pressurized liquid to be ejected from the plenum 102. The openings can be various different sizes and shapes as desired to suit a particular application.

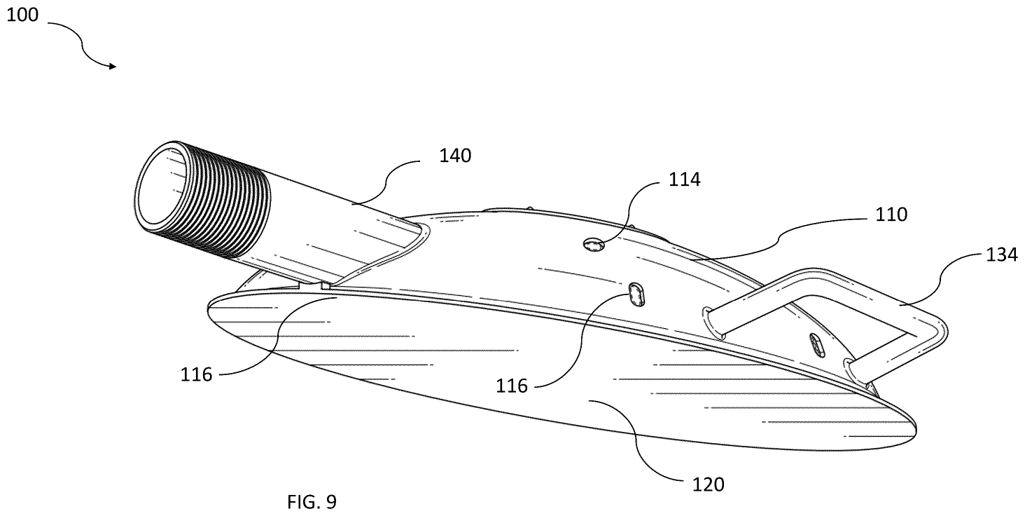

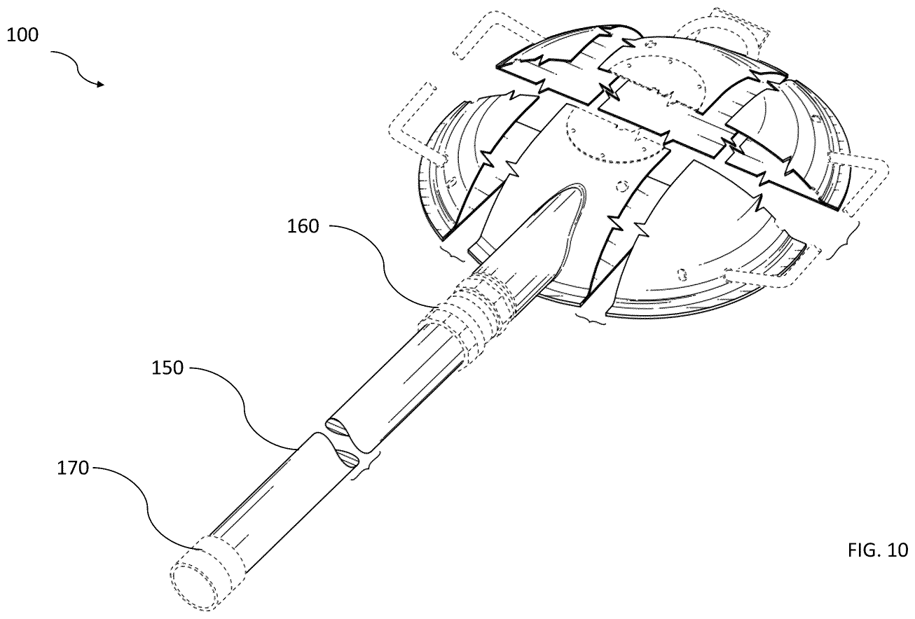

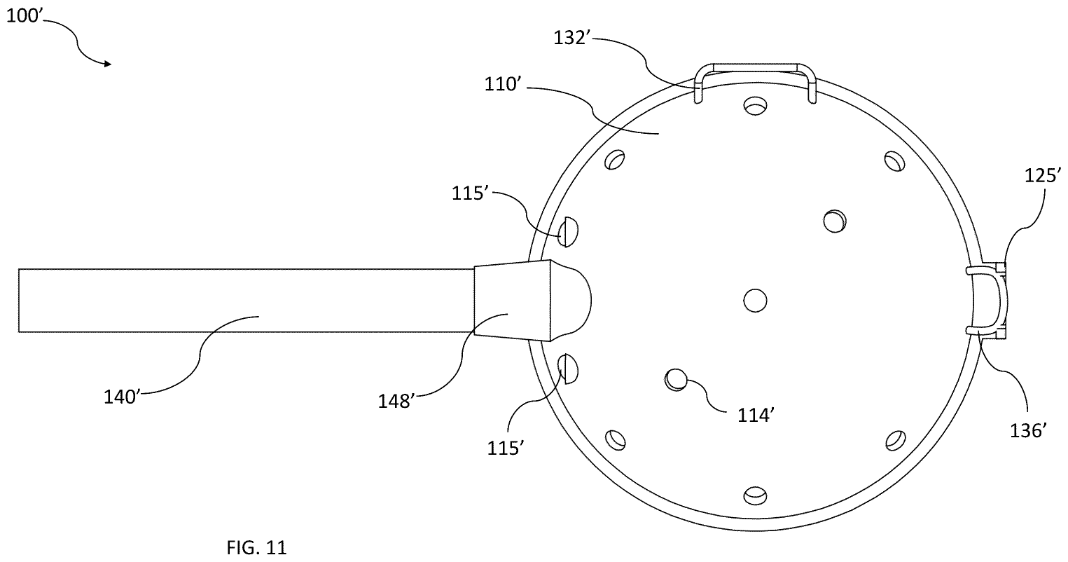

It will be appreciated that the base plate 120 can also be dish shaped, as desired. Preferably, an elongate conduit or pipe 140 extends laterally outwardly from the body. In the depicted implementation, the pipe extends along and defines a longitudinal axis of the device, and the shell 110 and base 120 are mated with the pipe. The pipe can be oriented parallel to the base 120. It will be appreciated that the base plate and shell can be angled off the axis of the pipe such that it is not symmetrically oriented when viewed in a top plan view. The device 100 preferably has a low horizontal profile to permit the device 100 to be slid underneath a burning vehicle or introduced into other hard to reach locations. Conduit 140 terminates in a free end that can include a coupling and or one or more elements of a fastener such as a threading 144. Conduit 140 can similarly terminate in a quick connect flange or other connector, discussed in further detail below. Conduit can be of any desired length, for example between about six inches and about ten feet in length, or any increment therebetween of about one inch. The selected components permit a user to operate device 100 from a relatively safe distance from an electric vehicle fire or other fire. The threading 144 or other coupling can connect to another length of rigid conduit (see, e.g., FIGS. 10-11 below) as desired. The free end of the conduit 140 or an extension pipe (150, discussed below) can in turn be connected to a connector of a firehose. When water or other liquid is then turned on, water can then flow through the firehose to the device and out towards a burning object. Thus, implementations of the present disclosure can include a firehose attachment that can easily be deployed underneath an electric vehicle to efficiently aid in extinguishing an electric vehicle fire quickly and from a relatively safe distance. The conduit 140 and/or any rigid pipe connected thereto can be used to push the device 100 underneath a vehicle, and act as a crush-resistant flow conduit if the electric vehicle's tires should collapse resulting in the bottom of the car falling on top of device 100. The rigid conduit 140/150 can then permit water or other fluid to continue flowing to the location of the fire. The rigid conduit 140/150 can also act as a thermal break to help protect the fire hose. If a firehose were extending underneath the car, it would not likely continue to deliver the same amount of water to the device 100, and the firehose could get damaged or burned if it is too close to the fire.

Implementations in accordance with the present disclosure can discharge upwards of 400 gallons of water per minute through the base. For example, a preferred volume flowrate of water can include about 350-500 gallons per minute, in increments of about one gallon per minute. However, in applications where available water flow rates are not as high the size, shape and number of openings 114, 116 can be modified to provide a suitable liquid jet through the openings to accommodate the lower flow rate.

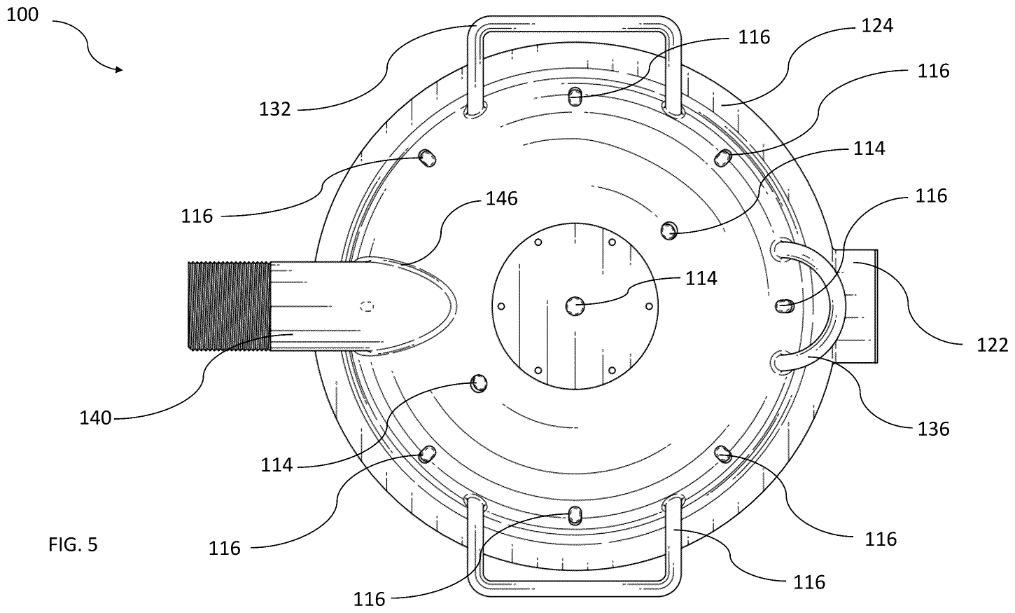

As illustrated in the figures, the shell 110 and base 120 can be made of a metal material that can withstand high temperatures with a semi-spherical shape as seen in FIG. 5. The semi-spherical shape (which may resemble a spherical section or similar shape, such as an oblate spheroid) further allows the flowing water or other liquid to reach a maximum flow rate without excessive interfering turbulence. The base 120 can comprise a base plate that can be slid along the ground that terminates in a ramped portion 122. The ramped portion 122 can help the device 100 slide over debris as it is being pulled or pushed to a location where device 100 is to be used. The base 120 and the upper shell 110 are preferably formed from a metallic material, such as steel sheeting or plating (stainless or carbon steel) of a sufficient thickness (e.g., one eighth of an inch to three eighths of an inch in thickness) to permit repeated use and an abusive environment. The base 120 and the shell 110 are preferably joined about their peripheries by a welded connection in order to form a fluid tight interface. Preferably, the conduit 140 is welded to at least one of the lower plate and the upper curved peripheral surface at a weld interface 146 (FIG. 5). The plurality of openings 114, 116 are illustrated as being formed by a series of circular and elongate holes spaced around the surface of shell portion to allow for a pressurized liquid, such as water to easily spray outwards and cover a large amount of area underneath an electric vehicle, for example.

With reference to FIG. 10, as mentioned above, the threaded connection 144 of conduit 140 can function as a port to receive a threaded coupling and/or extension pipe 150 (FIG. 10). Threads 144 of the conduit 140 can couple to a threaded collar 160 that is in turn coupled to an extension pipe 150. Extension pipe 150 terminates in a further coupling 170 that can be configured, for example, to couple to a firehose. One or both of the couplings 160, 170 may be rotatably rigid, or may allow relative rotation between conduit 140 and extension pipe 150, and/or extension pipe 150 and the firehose (not shown).

With continuing reference to FIGS. 1-10, a loop 136 is positioned on the opposite side of the conduit 140. The loop is preferably composed of a metallic material that is welded to the lower plate 120 and/or upper surface of the shell 110. The loop 136 allows a chain or other implement or tool to be connected to the device 100 to pull the device 100 underneath an electric vehicle from an opposing side of the electric vehicle to deploy the device. For example, in use a chain (not shown) can be advanced underneath an electric vehicle from a first side of the vehicle to a second side of the vehicle, wherein the chain is secured to the loop 136 or other portion of device 100, and further wherein the conduit and/or extension is connected to a fire hose. The device 100 can then be pulled under the burning vehicle, and the water can be turned on.

Furthermore, as illustrated in FIGS. 1-10 one or more laterally placed handles 132, 134 can be attached to an outer surface of the shell 110 or to the base plate 120. As with the loop 136, the handle(s) 132, 134 are also preferably metallic with a bracket shape or a “C” shape. The handle 132, 134 are preferably designed to allow a user to easily pickup and transport the device 100 or provide an additional connection point for pulling or pushing the device 100. If desired, additional handles or loops can be provided to pull or push the device 100.

FIG. 11 illustrates a further implementation 100′ of a device in accordance with the present disclosure. Reference numbers of implementation 100′ substantially correspond to reference numbers of embodiment 100, with certain differences. For example, on the side of the shell portion 110′ closest the conduit 140′, where the conduit 140′ enters shell portion 110′ via coupling 148′, two holes 115′ are defined through the shell portion 110′. These holes 115′ can be configured to function as insertion points wherein a user can push the device into place using pike poles.

In further accordance with the disclosure, the base plate 120 and upper shell portion 110 can be created in many various shapes and sizes, and the plurality of holes (114, 114′, 115′, 116, 116′) can be positioned in various locations on the shell portion 100, 110′. Each of the holes can be of the same, or different sizes. For example, the holes can have a diameter of about 8 mm to 25 mm or any diameter therebetween in increments of 1 mm. For example, the three holes 114 arranged diagonally across the top of device 110 can be larger than the other holes to permit more water to be ejected from those holes along the length of the vehicle, and the other holes 116 can be configured to aim toward the battery pack. The holes can similarly be beveled or “angled” to help direct water at particular directions. That is to say, the hole can be formed through the shell portion 110 so that the sidewalls of the hole are pointed in a direction where it is desired to direct water or other pressurized fluid. The exit ports or holes 114, 115′, 116, for example, can be round and circular, or elongated with rounded ends, or of any other shape, including slit-shaped, circular, oval, rectangular, triangular, and the like.

As mentioned above, the firehose connection can be secured to the device via a threaded connection 144 on the pipe or conduit 140 that extends outwardly from the shell portion 110. In the present disclosure, the combination of the shell portion 110 and the base plate 120 is referred to as the base or base portion of device 100. The pipe or conduit 140 can be of any desired length between, for example, about 6 and about 72 inches, or any length therebetween in increments of one inch. If desired, a flange 125′(FIG. 11) can be provided attached to the upwardly curved surface of the base 110′/120′. As referenced above, providing a conduit 140 in the form of an elongate pipe, such as a steel pipe, can be beneficial as the pipe can more readily tolerate exposure to the heat of a battery pack fire than the fire hose itself, which could suffer burn through in such an event. The hose connection, or pipe (e.g., 144, 160, 170), can be designed with a hollow cylindrical shape with a steel material and can be threaded into a flange (e.g., ′148 in FIG. 11) on the base 110′/120′ or can be directly welded to the base 110/120 as depicted in FIGS. 1-10. For example, if a threaded flange 148′ is provided on the base 110′/120′, a user can select pipes of different lengths to be screwed into the device 100′ to account for different conditions. This can similarly be accomplished through the use of extension pipes 150 of different lengths in the embodiment of FIGS. 1-10. The hose connection that is used allows for a standard fire hose to be attached to the device 100/100′, allowing for water or other pressurized fluid to flow from the firehose through the base and outwards towards the electric vehicle (or other target) on fire at a high pressure with a high-volume flow rate to maximize heat transfer. These implementations allow the hose connection to easily be rotatably secured to the base 110/120; 110′/120′ and tightened as needed. With all the components working together it will be appreciated that the disclosure provides implementations of a firehose attachment that can easily be deployed underneath an electric vehicle to efficiently aid in extinguishing an electric vehicle fire quickly and from a relatively safe distance.

The extension pipe 150 can be used to deliver the water or other fluid and can be used to help deploy the device. For example, an extension pipe 150 of suitable length can be chosen, taking into account the distance to be traversed by the device 100 and pipe 150, and any hot or otherwise dangerous conditions that exist. If desired, the conduit 140/140′ and/or extension pipe 150 can be provided with one or more notches that allow a user to either tighten or loosen the threaded connection, as desired.

In some implementations, the disclosed embodiments can be used effectively for engine compartment fires in internal combustion engine vehicles as well by sliding the device under the car in the region of the engine and turning on the water without a need for opening the hood, which is considerably safer than a traditional approach of opening the hood. Also, the device can be slid under a garage or warehouse door to help cool an area before opening the door to permit fire department personnel to enter the structure. Furthermore, a hole can be cut through the wall of a burning structure and the device 100 can be slid through the hole and turned on to begin cooling the burning structure.

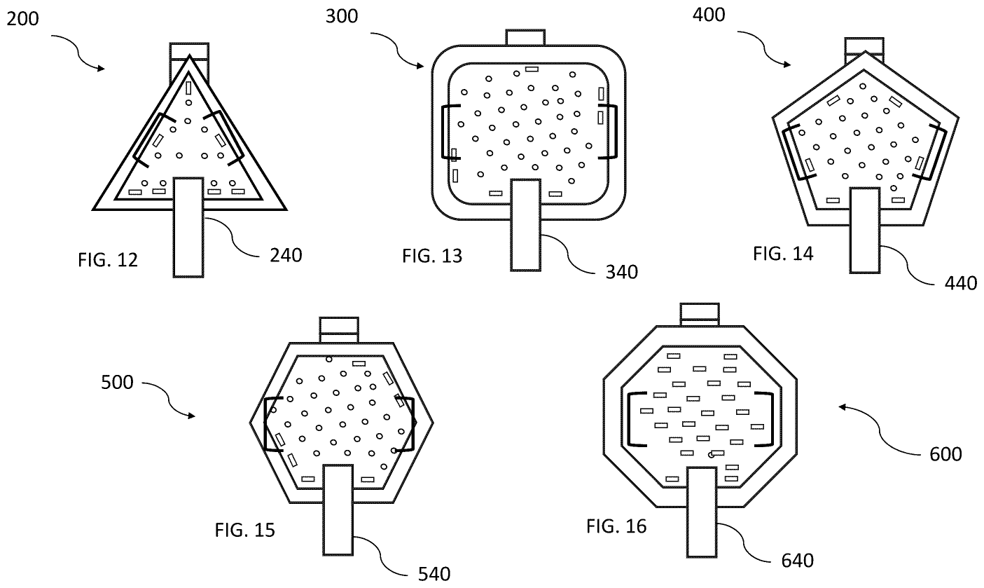

FIGS. 12-16 depict top plan views of alternate devices in accordance with the present disclosure, wherein the main element that has been varied is the top planform shape of the device. FIG. 12 depicts a triangular device 200 that has a fluid entry conduit 240 that leads into an internal cavity that is generally triangularly shaped through one of the sides of the triangular device, but it will be appreciated that the conduit 240 could enter along a direction that is coincident with a corner of device 200. Device 300 of FIG. 13 is a generally square or rectangular device having an entry conduit 340 that leads into an internal cavity that is generally rectangularly shaped through one of the sides of the rectangular device. Device 400 of FIG. 14 is a generally pentagonal device having an entry conduit 440 that leads into an internal cavity that is generally pentagonally shaped through one of the sides of the pentagonal device. Device 500 of FIG. 15 is a generally hexagonal device having an entry conduit 540 that leads into an internal cavity that is generally hexagonally shaped through one of the sides of the hexagonal device 500. Device 600 of FIG. 16 is a generally octagonal device having an entry conduit 640 that leads into an internal cavity that is generally octagonally shaped through one of the sides of the octagonal device 600.

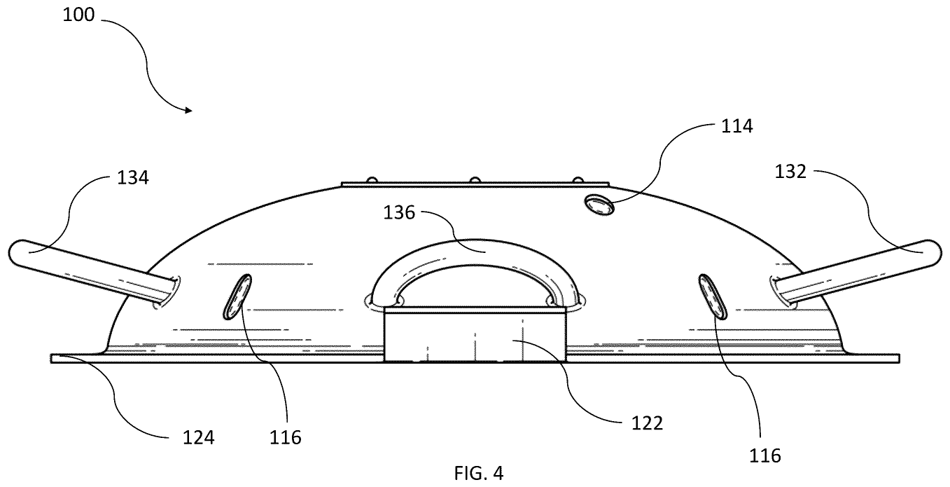

As depicted, the devices can define a peripheral lip about the periphery of the main body portion (e.g., 110/120) of each device. For example, with reference to FIG. 4, a flattened peripheral edge or lip 124 is provided that surrounds the device. This can be formed from an overlap region of components 110, 120 and a peripheral weld that joins the two portions 110, 120. Each embodiment depicted herein (e.g., 100′, 200-700) may include such a peripheral lip, if desired. Moreover, the embodiments 200-600 may have relatively sharp corners (e.g., FIG. 12), or rounded corners (e.g., FIG. 13).

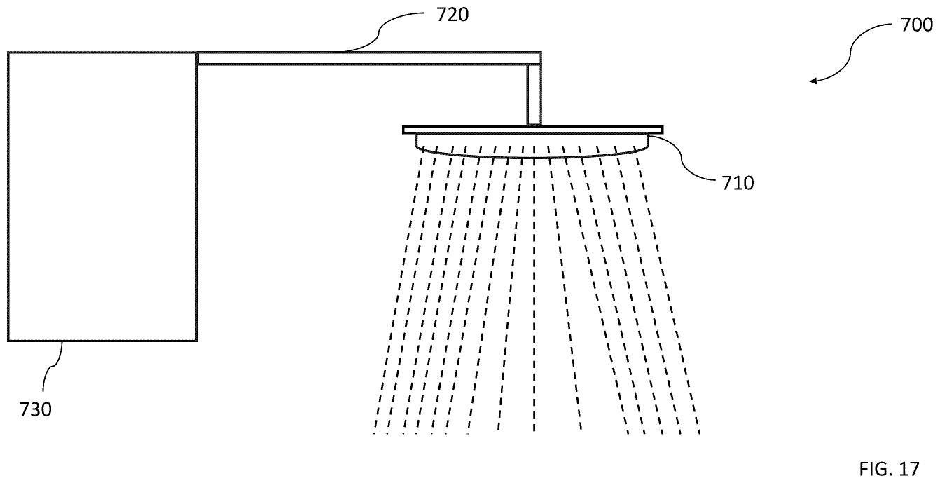

FIG. 17 depicts a further implementation of a stationary system 700 (e.g., permanent fire suppression system) that utilizes a device 710 that is similar in construction to the base portions of any of devices 100-600, and 100′, for example. The device 710 can be connected to a supply line 720 that in turn is coupled to a source 730 of pressurized fluid. In use the system can be used to direct large volumes of cooling fluid to a target region to be cooled, such as a boiler, a reactor, and the like.

The main base or body portion of the device 100, 100′, 200-600, 710 can be of any desired lateral dimension, and is preferably between about ten and about thirty-six inches in lateral dimension, or any increment between those amounts in increments of about one half of an inch. The height of the device 100, 100′, 200-600, 710 can be between about two and about eight inches in height, if desired, or any increment therebetween of about 0.25 inches. The conduit (e.g., 140) extending laterally outwardly from the device (e.g., 100) is preferably between 1.0 and about 3.0 inches in diameter in standard pipe size, or any increment therebetween of about 0.25 inches. The device is typically configured to experience an internal pressure between about 100 and 140 psi. If desired, the device can be formed from upper and lower plates of the same or different sizes connected by a peripheral sidewall, and may resemble a cylinder or a conic section, if desired.

The Example of an implementation set forth below is meant to be illustrative of the disclosed embodiments and non-limiting.

### Example

In accordance with one implementation, a device is provided resembling those in FIGS. 1-10.

In such an implementation the conduit 140/150 can comprise ASME B36.10M Schedule 40 mild steel. The outside diameter (O.D.) of the conduit can be 2.875 inches, and the wall thickness can be about 0.203 inches. The extension pipe 150 can be 60 inches in length. Both ends of the extension pipe can be threaded with NPT, short for national pipe taper. In long form this thread is referred to as “American National Standard Taper Pipe Thread. The length of pipe 150 gives firefighters the ability to push the device (e.g., 100) forward from a comparatively safer position than if they had to push the device 100 without the extension pipe 150. The extension pipe 150 offers firefighters the rigidity to push the device 100; relative to that of a pressurized firehose considering the propensity of firehose to kink when pushed. Extension pipe 150 withstands high temperatures and continues to permit water to flow water long after standard firehose will have failed due to thermal degradation. The extension pipe 150, and the device 100 are sufficient to tolerate the weight of a passenger vehicle if, after being positioned under burning vehicle, the tires and rims were to burn away. Not providing an extension pipe, or a sufficiently long conduit 140 would let the weight of a vehicle pinch a firehose, which would reduce, or more likely stop, the flow of water.

The coupling 160 (FIG. 10) can include a cam and groove coupling, sometimes referred to as a camlock fitting, which is used to connect two hoses and or pipes together. This connection can be connected or disconnected quickly, which can be important due to limited time for fighting a fire, and the difficulty of using wrenches when wearing firefighter turnout gear and gloves. In this example, the cam and grove couplings that comprise coupling 160 are each outfitted with 2½″ female NPT threads to receive threaded connection 144 on one part of the fitting, and a threaded connection from extension pipe 150 on the other part of the cam and groove coupling. The non-threaded connection offered by the cam and groove system ensures that the end user is unable to directly couple a firehose to the device 140 without first attaching the extension pipe 150. In effect, this design element prevents the extension pipe 150 from being omitted during deployment.

A firehose to pipe connection (e.g., 170 in FIG. 10) is provided to couple the system to a water supply. Specifically, coupling 170 can comprise a 2½″ double female coupling that is also threaded NPT (National Pipe Taper) on the pipe side and NH (National Hose) on the firehose side. The firehose side of coupling 170 may be selected or adapted to meet the requirements of any department's male firehose threads. Preferably, after the assembly is complete, the coupling 170 is configured such that the fire hose side of the coupling 170 retains the ability to spin to prevent kinking and to facilitate device deployment. The double female coupling allows for a semi-permanent NPT threaded connection to the extension pipe 150, while the other side of the coupling presents the end user with a firehose compatible female thread. This coupling is very useful to permit an end user the ability to connect their male threaded hose to the extension pipe 150. As mentioned above, the double female coupling allows the supply hose to rotate and self-correct any kinks. These kinks are often unavoidable and are commonly observed during hose deployment.

The present disclosure further provides a variety of methods of use of the disclosed embodiments. The disclosed embodiments were designed and developed to adapt to the ever-evolving fire service and to support the safety of fellow firefighters and the communities they serve. While it was born from a need to address the growing concern of electric vehicle fires, the applications for the Turtle Fire System stretch far beyond this purpose.

Primary uses of the disclosed embodiments typically include suppressing thermal runaway on electric vehicles. If an electric vehicle battery suffers structural damage due to a crash, a disclosed device can be deployed as a proactive suppression tactic intended to allow enough time for occupant rescue. In some implementations, the disclosed embodiments can be can be deployed and supplied with a comparatively low flow rate of liquid (e.g., 80-100 GPM), as a precautionary measure under any vehicle at risk of ignition after a motor vehicle accident. Due to the high potential flow rate that the disclosed embodiments can endure, (e.g., 500 GPM or more), and due to the large resulting flow pattern (35-40 ft high) and 30 ft in diameter over a 360 degree extent) of the disclosed embodiments, the disclosed embodiments can be used with both low-profile cars as well as high-profile vehicles such as trucks, buses, and the like.

In some implementations, the disclosed embodiments can be used inside the cabin of an electric vehicle when deployed through a window to flood the lithium-ion battery from the top. Moreover, the disclosed embodiments can be used to extinguish fires for alternate fuel vehicles, compressed natural gas (CNG) vehicles, hydrogen, and other various new battery cell technologies (sodium phosphate, sodium ion) and electrochemical fuel cells powered by hydrogen, methanol and the like. The disclosed embodiments can be used to cool burning fuel storage tanks or even those only under threat of fire, such as fuel oil/diesel storage tanks, waste oil storage tanks commonly found at auto repair facilities, restaurants, and refineries, pressure vessels of compressed natural gas, liquid propane, oxy acetylene, and the like.

The disclosed embodiments can also be used in combination with the standpipes of parking structures and high-rise structures. For example, per NFPA 14, a high rise is required to deliver a combined 500 gpm from the 2 most hydraulically remote outlets on the most remote standpipe. The standpipes are also required to supply no less than 100 psi and no more than 175 psi. An additional 250 gpm must remain in the system for firefighters to use at each additional standpipe. In practice a system must be able to deliver a water volume flow rate up to 1000 gpm or 1250 gpm depending on the sprinkler configuration. When a structure fire threatens to spread to an adjacent property, multiple firefighting crews can often be needed to direct an effective volume of water onto the exposed structure. By flowing more than 500 gpm, the disclosed embodiments can deliver the volume of three 2½″ hand lines. Also, once deployed, the disclosed embodiments do not require active monitoring and can be left fully operational, even in the collapse zone. This autonomy allows incident commanders to reassign their exposure protection crews to more pressing matters. The force multiplying factor the disclosed embodiments can afford firefighters is considerable.

In alternative implementations, the disclosed embodiments can also be deployed in lower flowrate regimes. For example, the disclosed embodiments can be positioned under any vehicle thought to be at risk of ignition. This can include anything from an internal combustion vehicle involved in a multi vehicle accident, for example, or an electric vehicle stored in the garage of a burning building.

In still further implementations, the disclosed embodiments can be deployed at HAZ-MAT incidents, and can be used for the decontamination of firefighters, civilians, hoses, equipment, fire apparatus, and the like. Moreover, when faced with deep seated fires in untenable or hard to reach areas of a structure, the disclosed embodiments can be deployed and left behind to extinguish fire while crews evacuate to safety. The disclosed embodiments can be used in maritime applications such as port-hubs accepting shipments of EV and hybrid vehicles, vehicles on ferries, and the like.

In further implementations, the disclosed embodiments can be deployed on top of and underneath bridges, tunnels, and parking lots. For example, if a vehicle catches fire underneath a bridge, the heat can weaken the bridge. The disclosed embodiments can be deployed in these settings, attached to a boom of a robot, for example, to deliver a large volume flow rate of water to such a location to minimize damage to the bridge or roadway above. In some implementations, the disclosed embodiments can be used to fight fires involving metal truss roof or bow string construction. For example, before withdrawing firefighters from such a structure, the Incident Commander can order the disclosed embodiments to be deployed to cool the trusses to prevent collapse. The disclosed embodiments can be left behind to aid in extinguishment while crews evacuate to safety.

In accordance with further examples, the disclosed embodiments can be used for large area coverage applications, such as in recycling plants, scrap yards, refineries, wild land fires, large mulch pile fires, and garbage dumps, the latter of which are increasing due to the improper disposal of lithium-ion batteries with household trash. The disclosed embodiments can be very effective in trailer park fires, wherein the disclosed embodiments are deployed in crawl spaces underneath a trailer.

In further implementations, the disclosed embodiments are also capable of flowing fire suppression agents such as foam or F500, as long as such product can be passed through the fire hose to the device (e.g., 100), whether through a fire engine or an inductor.

In further implementations, the disclosed embodiments can be modified for permanent mounting as part of a deluge sprinkler system, as depicted in FIG. 17. Unit 710 can be configured for off the shelf use to be coupled to a standpipe by a sprinkler installation company. Thus, the present disclosure contemplates building sprinkler systems incorporating implementations of the disclosed embodiments. In such applications the size of the device (e.g., 100) can be adjusted and optimized for a particular application. In further implementations, the disclosed embodiments can be incorporated into new and existing suppression systems and used as a deluge sprinkler system, capable of delivering copious amounts of water from the ground up. As an example, the disclosed embodiments can be permanently mounted in the ground at EV charging stations, designated EV parking spaces within a parking structure, and the like. The disclosed embodiments can be hooked up to either a wet or dry system and be pre-piped to a Fire Department rated riser, allowing fire departments to hook up at a safe distance and flow water.

This description and the accompanying drawings that illustrate various embodiments should not be taken as limiting. Various mechanical, compositional, structural, electrical, and operational changes may be made without departing from the scope of this description and the invention as claimed, including equivalents. In some instances, well-known structures and techniques have not been shown or described in detail so as not to obscure the disclosure. Like numbers in two or more figures represent the same or similar elements. Furthermore, elements and their associated features that are described in detail with reference to one embodiment may, whenever practical, be included in other embodiments in which they are not specifically shown or described. For example, if an element is described in detail with reference to one embodiment and is not described with reference to another embodiment, the element may nevertheless be claimed as included in the other embodiment.

For the purposes of this specification and appended claims, unless otherwise indicated, all numbers expressing quantities, percentages, or proportions, and other numerical values used in the specification and claims, are to be understood as being modified in all instances by the term “about,” to the extent they are not already so modified. Accordingly, unless indicated to the contrary, the numerical parameters set forth in the following specification and attached claims are approximations that may vary depending upon the desired properties sought to be obtained. At the very least, and not as an attempt to limit the application of the doctrine of equivalents to the scope of the claims, each numerical parameter should at least be construed in light of the number of reported significant digits and by applying ordinary rounding techniques.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Further, this description's terminology is not intended to limit the invention. For example, spatially relative terms—such as “beneath”, “below”, “lower”, “above”, “upper”, “proximal”, “distal”, and the like—may be used to describe one element's or feature's relationship to another element or feature as illustrated in the figures. These spatially relative terms are intended to encompass different positions (i.e., locations) and orientations (i.e., rotational placements) of a device in use or operation in addition to the position and orientation shown in the figures. For example, if a device in the figures is turned over, elements described as “below” or “beneath” other elements or features would then be “above” or “over” the other elements or features. Thus, the illustrative term “below” can encompass both positions and orientations of above and below. A device may be otherwise oriented (rotated 90 degrees or at other orientations) and the spatially relative descriptors used herein interpreted accordingly.

Further modifications and alternative embodiments will be apparent to those of ordinary skill in the art in view of the disclosure herein. For example, the devices and methods may include additional components or steps that were omitted from the diagrams and description for clarity of operation. Accordingly, this description is to be construed as illustrative only and is for the purpose of teaching those skilled in the art the general manner of carrying out the present teachings. It is to be understood that the various embodiments shown and described herein are to be taken as illustrative. Elements and materials, and arrangements of those elements and materials, may be substituted for those illustrated and described herein, parts and processes may be reversed, and certain features of the present teachings may be utilized independently, all as would be apparent to one skilled in the art after having the benefit of the description herein. Changes may be made in the elements described herein without departing from the spirit and scope of the present teachings and following claims.

It is to be understood that the particular examples and embodiments set forth herein are non-limiting, and modifications to structure, dimensions, materials, and methodologies may be made without departing from the scope of the present teachings.

Other embodiments in accordance with the present disclosure will be apparent to those skilled in the art from consideration of the specification and practice of the invention disclosed herein. It is intended that the specification and examples be considered as illustrative and for example only, with the following claims being entitled to their fullest breadth, including equivalents, under the applicable law.

1. A device for aiding in extinguishing fires, comprising a body surrounding a volume defining a fluid plenum, the body defining a plurality of exit ports therethrough to direct pressurized fluid at a target, and at least one fluid input port to couple to a pressurized fluid source.

2. The device of claim 1, wherein the body is defined by a base plate configured to be slid along the ground and an upper surface above the base plate, wherein the base plate and the upper surface cooperate to define the fluid plenum, and the wherein the plurality of exit ports are formed through the upper surface.

3. The device of claim 2, further comprising a conduit fluidly coupled to one or more of the base plate and upper surface, wherein the conduit terminates in the fluid input port, the fluid input port being configured to be coupled to a fire hose.

4. The device of claim 1, wherein the device is between about twelve and about thirty inches in lateral dimension, and between about two and about eight inches in height.

5. The device of claim 2, wherein the base plate and the upper surface are fused along their periphery to form the fluid plenum.

6. The device of claim 1, wherein the device is configured to direct between about 300 gallons per minute and about 500 gallons per minute through the plurality of exit ports.

7. The device of claim 2, wherein the base plate defines a ramped portion to facilitate sliding the device along the ground, wherein the ramped portion is located on the body in a location that is across from the fluid input port.

8. The device of claim 3, wherein the conduit extends along a direction parallel to the base plate.

9. The device of claim 3, further comprising an extension conduit removably coupled to the conduit.

10. The device of claim 1, wherein the body has a circular shape when viewed in a top view.

11. The device of claim 3, wherein the body and conduit are formed from steel.

12. A method of extinguishing a fire comprising providing a device of claim 1, coupling the device to a fluid source, deploying the device proximate a fire, and extinguishing the fire.

13. The method of claim 12, wherein the fire is an electric vehicle (“EV”) fire.

14. The method of claim 13, wherein the device is deployed by sliding the device underneath the battery pack of the EV, and wherein the extinguishing step includes directing water through the device to cool the battery pack of the EV.

15. The method of claim 14, wherein the device is slid under a first side of the electric vehicle by pulling it under the vehicle from a second side of the electric vehicle.

16. The method of claim 13, wherein water is directed through the device and into contact with the EV at a volume flow rate between about 80 GPM and about 500 GPM.

17. The method of claim 13, wherein water is directed through the device and into contact with the EV at a volume flow rate between about 350 GPM and about 500 GPM.

18. The method of claim 13, wherein water is directed through the device and into contact with the EV at a volume flow rate between about 450 GPM and about 500 GPM.

19. (canceled)

20. The device of claim 1, wherein the device includes less than about 12 exit ports.

21. A stationary fire suppression system comprising a high-pressure standpipe coupled to a device according to claim 1.
